(19) United States
(12) Patent Application Publication
(10) Pub. No.: US 2010/0081103 A1
(43) Pub. Date: Apr. 1, 2010

(54) FURNACE WITH MULTIPLE HEAT RECOVERY SYSTEMS

(76) Inventor: HISASHI KOBAYASHI, Putnam Valley, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 12/238,591

(22) Filed: Sep. 26, 2008

(51) Int. Cl. F26B 23/00; C03B 19/00

(52) U.S. Cl. 432/1; 65/66

(57) ABSTRACT

In a furnace such as a glassmelting furnace, a portion of the combustion products formed by combustion of fuel with gaseous oxidant within the furnace are passed through a recuperative or regenerative heat exchanger system to heat a portion of the incoming gaseous oxidant, and a portion of the combustion products are passed instead through a secondary heat exchanger system, wherein the hot combustion products and oxidant which are passed through said first heat exchanger are passed at a heat capacity rate ratio of combustion products to oxidant of less than 1.3.

### FIELD OF THE INVENTION

The present invention relates to the energy efficient production of glass in a furnace, and more particularly to the method of heat recovery from hot combustion products formed in the combustion that is carried out to generate heat for melting glassmaking material.

### BACKGROUND OF THE INVENTION

Many industrial operations employ furnaces within which fuel and oxidant are combusted so that the heat of combustion can heat material that is in the furnace. Examples include furnaces that heat solid material to melt it, such as glassmelting furnaces. Other examples include furnaces that heat solid material or objects such as steel slabs, to raise the material's temperature (short of melting it) to facilitate shaping or other treatment of the material or object. The challenges that furnaces present are illustrated in glassmelting furnaces, and much of the description herein of the present invention is described with reference to glassmelting furnaces, but the present invention is applicable as well to furnaces used for many other functions.

Conventional glassmaking methods require establishing in a glassmelting furnace temperatures that are high enough to melt the glassmaking material (by which is meant one or more materials which are not glass but are ingredients in the formation of glass, such as sand, soda ash, limestone, dolomite, feldspar, rouge, which are collectively known as “batch”, and/or broken, scrap and recycled glass, known as “cullet”). The required high temperature is generally obtained by combustion of hydrocarbon fuel such as natural gas. The combustion produces gaseous combustion products, also known as flue gas. Even in glassmaking equipment that achieves a relatively high efficiency of heat transfer from the combustion to the glassmaking materials to be melted, the combustion products that exit the melting vessel typically have a temperature well in excess of 2000° F., typically in a range of 2600 to 2950 F, and thus represent a considerable waste of energy that is generated in the glassmaking operations unless that heat energy can be at least partially recovered from the combustion products.

The prior art has addressed this problem by using flue gas-to-air heat exchangers, often of the types known as recuperators or regenerators. As used herein, a “recuperator” is a heat exchanger through which two streams can each flow continuously without direct physical contact with each other, wherein if the streams have different temperatures as they enter the recuperator then heat flows within the recuperator from the stream having a higher temperature through the to the stream having a lower temperature. As used herein, a “regenerator” is a heat exchanger comprised of two or more units (or “beds”), wherein one stream at a time can be passed through each bed and the unit through which each stream flows can be periodically alternated (“reversed”) from one bed to another and then back (or to yet another bed), wherein the hotter stream heats the unit through which it passes while the cooler stream passes through another unit which had already been heated by the hotter stream passing through it, and then the cooler stream passes through the now-heated unit and is heated by the unit while the hotter stream is passed through another unit from which heat has been exchanged to the cooler stream.

In a conventional air fired recuperative or regenerative furnace, in which fuel is combusted with air as the source of oxygen and the products of the combustion are passed through recuperative or regenerative heat exchanger to heat the incoming combustion air, waste heat in the flue gas is partially recovered in the heat exchanger by preheating the incoming combustion air and the exit temperature of the flue gas after passing through a typical regenerative heat exchanger is reduced to about 800 to 1000° F. or after passing through a typical recuperative heat exchanger is reduced to about 1000 to 1600° F. Although substantial improvements have been made during the last century in the design of regenerators and recuperators to recover waste heat, there is an inherent limitation in the maximum amount of waste heat recoverable in these heat recovery devices. The heat capacity rate of the flue gas stream is typically about 35% more that the heat capacity rate of combustion air. Thus, even with a thermodynamically ideal regenerator where the air preheat temperature approaches the temperature of the entering hot flue gas, at least 26% [(1.35-1.0)/1.35=0.26] of the enthalpy content of the entering flue gas remains in the flue gas after passing through the regenerator. (A. R. Cooper and Y. Wu: Analysis of Various Modifications on the Thermal Performance of Combustion Heated Continuous Glass Melting Furnaces, Proc. of 16th Intl Congress on Glass, 6, 59-64, Madrid, Spain, Oct. 4-9, 1992). Thus, further improvements in overall heat recovery require a secondary heat recovery system to recover sensible heat contained in the flue gas after the regenerative or recuperative heat exchanger. Prior art methods of secondary heat recovery include a waste heat boiler, a batch/cullet preheater, and a natural gas preheater. A waste heat boiler can efficiently recover waste heat as steam and generate power by using a steam turbine. However, the maximum achievable temperature and pressure of steam is limited by the relatively low temperature of the waste flue gas stream after a regenerator or a recuperator.

While the glassmaking art is aware of using heat in the hot gaseous combustion products from the glassmelting furnace to preheat incoming glassmaking material which is to be melted in the manufacture of the glass, the heretofore known technology has believed that the temperature of the hot combustion products should not exceed about 1000 to 1300° F. as it commences heat exchange with the glassmaking material. This maximum temperature is imposed by considerations of the capability of the materials from which the heat exchanger is constructed to withstand higher temperatures, and considerations of the tendency of the glassmaking material to begin to soften and become adherent (or “sticky”) if it becomes too hot during the heat exchange step, leading to reduced throughput and even plugging of the heat exchanger passages. The temperature at which the glassmaking material becomes adherent or sticky depends on the batch composition and the material in contact with the glassmaking material and is believed to be in a range between 1000 and 1300° F. for a common batch to make soda lime glass for bottles and windows. In a conventional air fired regenerative furnace, the flue gas exit temperature after the regenerators is about 800 to 1000° F. and there is no need to cool down the flue gas prior to a batch/cullet preheater. Several commercial container glass furnaces have adopted batch/cullet preheaters to heat the glassmaking material by utilize the waste heat contained the large volume of flue gas coming out of the regenerator. Because of the relatively low temperature of flue gas, however, the maximum preheat temperatures achieved by this method was limited to about 600° F. In addition the physical size of the commercially available batch/cullet preheater is very large in order to exchange heat with the large volume of flue gas, making it economically unattractive.

When the gaseous combustion products exiting the glassmelting furnace are at high temperatures such as the temperatures obtained by oxy-fuel combustion, the conventional belief has been that they need to be cooled to the range of from 1000 to 1300° F. before heat exchange with the incoming glassmaking materials can commence. Numerous examples exist showing the prior art's belief that the temperature of the flue gas must be reduced before the flue gas is used to heat incoming glassmaking materials. Such examples include C. P. Ross et al., “Glass Melting Technology: A Technical and Economic Assessment”, Glass Manufacturing Industry Council, August 2004, pp. 73-80; G. Lubitz et al., “Oxy-fuel Fired Furnace in Combination with Batch and Cullet Preheating”, presented at NOVEM Energy Efficiency in Glass Industry Workshop (2000), pp. 69-84; U.S. Pat. No. 5,412,882; U.S. Pat. No. 5,526,580; and U.S. Pat. No. 5,807,418.

However, reducing the temperature of this stream of combustion products by adding to it a gaseous diluent such as air, and/or spraying a cooling liquid such as water into the stream, is disadvantageous as such approaches reduce the amount of recoverable heat remaining in the gaseous combustion products, increase the size of the gas handling equipment that is needed, and adds additional equipment and process expense.

A recent advancement in the art of heat recovery from oxy-fuel fired glass melting furnaces is a high temperature radiative batch/cullet preheater proposed by the present inventor as described in the international patent application WO 2007/126685 A1. The new batch/cullet preheater is capable of heating the glassmaking material to as high as 1200 F using the hot flue gas from an oxy-fuel fired furnace without cooling it by cooling gas injection. However, the radiative batch/cullet preheater was hitherto considered not applicable for air fired regenerative or recuperative furnaces.

There is a need to improve the fuel efficiency of regenerative and recuperative furnaces, including glassmelting furnaces and other furnaces, by more effective waste heat recovery.

### BRIEF SUMMARY OF THE INVENTION

One aspect of the invention is a method of operating a furnace comprising

(A) combusting fuel in a furnace with gaseous oxidant having an overall average oxygen content of at least 20.9 vol. % oxygen to produce heat, and thereby producing hot combustion products;

(B) passing hot combustion products from said furnace, and a portion or all of said gaseous oxidant prior to combustion thereof in step (B), through a regenerative or recuperative primary heat exchanger system and heating the gaseous oxidant which is passed through said primary heat exchanger system by heat exchange in said primary heat exchanger system from the hot combustion products passed through said primary heat exchanger system, wherein the hot combustion products and oxidant which are passed through said primary heat exchanger system are passed at a heat capacity rate ratio of combustion products to oxidant of less than 1.3; and

(C) passing hot combustion products from said furnace that are not passed through said primary heat exchanger system through a secondary heat exchanger system and recovering sensible heat from said hot combustion products in said secondary heat exchanger system.

A preferred aspect of the present invention is a glassmelting method comprising

(A) passing glassmaking material into a glassmelting furnace;

(B) combusting fuel with gaseous oxidant having an overall average oxygen content of at least 20.9 vol. % oxygen to produce heat for melting said glassmaking material in said glassmelting furnace and thereby producing hot combustion products;

(C) passing hot combustion products from said glassmelting furnace, and a portion or all of said gaseous oxidant prior to combustion thereof in step (B), through a regenerative or recuperative primary heat exchanger system and heating the gaseous oxidant which is passed through said primary heat exchanger system by heat exchange in said primary heat exchanger system from the hot combustion products passed through said primary heat exchanger system, wherein the hot combustion products and oxidant which are passed through said primary heat exchanger system are passed at a heat capacity rate ratio of combustion products to oxidant of less than 1.3; and

(D) passing hot combustion products from said glassmelting furnace that are not passed through said primary heat exchanger system through a secondary heat exchanger system and recovering sensible heat from said hot combustion products in said secondary heat exchanger system.

As used herein, the “heat capacity rate” of a stream is defined as the mass flow rate of the stream times the mean specific heat of the stream evaluated between the temperature of the hot stream and the temperature of the cold stream and expressed in units of Btu/° F./hr or other equivalent units, and the “heat capacity rate ratio” of two streams is the ratio of the heat capacity rates of the two streams, i.e., a non-dimensional number.

As used herein, a heat exchanger “system” is apparatus comprising one or more heat exchangers. The “primary” heat exchanger system and the “secondary” heat exchanger system are each coupled to the furnace and not to each other, that is, they are not coupled in series such that gas heated in one passes into the furnace without passing through the other.

As used herein, “oxy-fuel combustion” is combustion of fuel with a gaseous oxidant whose oxygen content is higher than that of air, and “oxy-fuel burners” are burners at which oxy-fuel combustion can be carried out by virtue of the materials from which the oxy-fuel burners are constructed.

As used herein, “air-fuel combustion” is combustion of fuel with air, and “air-fuel burners” are burners at which air-fuel combustion can be carried out by virtue of the materials from which the air-fuel burners are constructed.

As described below, the relative volumes of said first and second streams of combustion products are preferably adjusted so that heat recovery efficiencies are optimized for both heat exchangers.

Another aspect of the invention is a method of modifying a furnace, comprising

providing a furnace wherein fuel and gaseous oxidant having an oxygen content of at least 20.9 vol. % can be combusted to produce heat for heating or melting material in said furnace and produce hot gaseous combustion products, and a primary heat exchanger system coupled to the furnace through which said hot combustion products can pass and through which said gaseous oxidant to be combusted in said furnace can pass and be heated by indirect heat exchange from said hot combustion products;

coupling to said furnace a secondary heat exchanger system so that said secondary heat exchanger system can receive hot gaseous combustion products from said furnace; and

providing one or more controllable dampers that can alter the volumes of said combustion products that are fed to said primary heat exchanger system and to said secondary heat exchanger system.

### BRIEF DESCRIPTION OF THE DRAWINGS

FIG. 1 is a schematic view of glassmaking apparatus with a recuperative heat exchanger useful with the method of the present invention.

FIG. 2 is a schematic view of glassmaking apparatus with a regenerative heat exchanger useful with the method of the present invention.

FIG. 3 is a schematic view of glassmaking apparatus incorporating the present invention.

FIG. 4 is a schematic view of glassmaking apparatus incorporating the present invention.

### DETAILED DESCRIPTION OF THE INVENTION

The present invention is applicable to furnaces within which fuel and oxidant are combusted. Preferred examples include glassmelting furnaces, steel reheating furnaces wherein a solid steel object such as a slab or billet can be heated, and aluminum melting furnaces wherein solid aluminum (such as aluminum scrap) can be heated and melted. The invention is described herein with principal reference to a glassmelting furnace without intending to be bound just to that type of furnace.

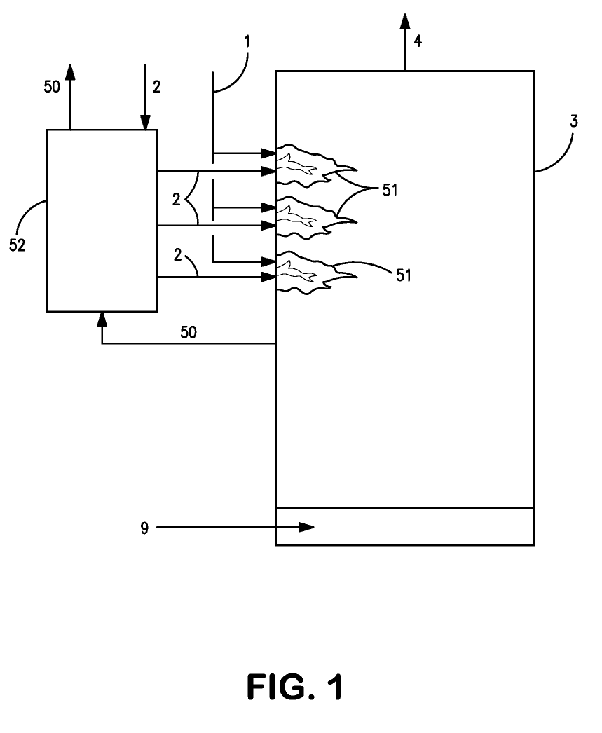

Referring to FIG. 1, fuel stream 1 and gaseous oxidant 2 are fed to glassmelting furnace 3 and combusted therein to generate sufficient heat to melt the glassmaking material present within furnace 3. Glassmaking material is fed as stream 9 to the furnace 3. Stream 4 of molten glass can be recovered from glassmaking furnace 3.

Suitable fuels include any that can be combusted with oxidant (air, oxygen enriched air or oxygen) to generate the required amount of heat of combustion. Preferred fuels include gaseous hydrocarbons, such as natural gas.

The fuel depicted as stream 1 and the oxidant depicted as stream 2 can each be fed as one stream to a solitary burner within furnace 3, but they are more often provided as a plurality of streams to each of several burners 51 within furnace 3. Considered over the aggregate of all such gaseous streams, the overall average oxygen content of all oxidant streams fed to and combusted in furnace 3 is at least that of air and is higher than 20.9% if oxygen enrichment or oxy-fuel burners are used. The oxygen content can be at least 35 volume percent oxygen, and more preferably at least 50 or even at least 90 volume percent oxygen. That is, the oxygen contents of the oxidant streams fed to different burners may differ from one another, for instance if the operator desires to have some burners (to which a higher oxygen content is fed) burn hotter than other burners. A preferred manner of obtaining a gaseous oxidant stream containing a desired oxygen content is to mix air and a gas having an oxygen content higher than that of air (such as a stream of 90 volume percent oxygen) either upstream from a particular burner or at the burner outlets.

The furnace before and after addition of the secondary heat exchanger system described below can be equipped entirely with burners that combust fuel with air, or with burners some of which combust fuel with air and some of which combust fuel with oxidant having a higher oxygen content than air. Furthermore, when as described herein a secondary heat exchanger system is added to the furnace, optionally one or more burners can be removed, or added, which combust fuel with air or which combust fuel with oxidant having a higher oxygen content than air. For burners that combust fuel with oxidant having a higher oxygen content than air, the oxidant is typically not preheated in heat exchangers.

Combustion of the fuel and oxidant produces hot gaseous combustion products. Some of these combustion products 50 are passed through primary heat exchanger system 52 to heat by indirect heat exchange with some or all of the incoming oxidant 2 that is to be fed to furnace 3. The primary heat exchanger system may employ two or more heat exchangers. Heat exchanger system 52 can comprise any type of heat exchanger that performs this function, such as a regenerative or recuperative heat exchanger system.

FIG. 1 illustrates practice with a single recuperative heat exchanger as the primary heat exchange system 52. Glassmelting furnaces that employ recuperative-type primary heat exchanger systems are often equipped with two recuperators as the primary heat exchanger system.

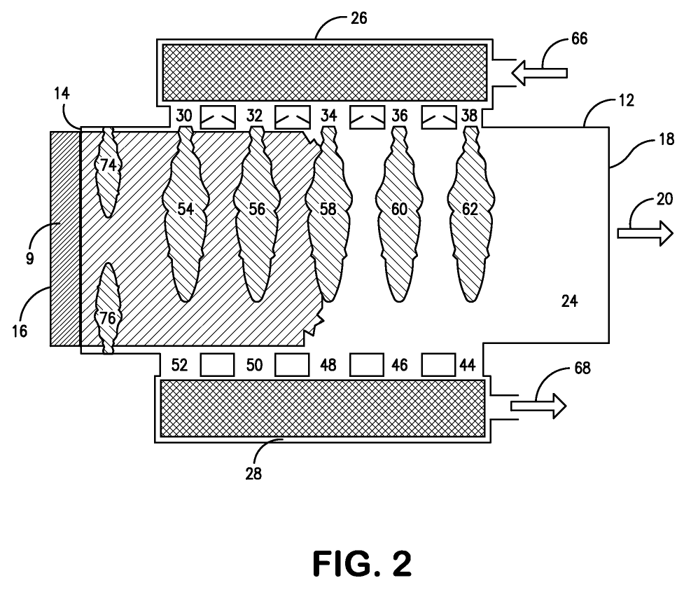

Referring to FIG. 2, a furnace includes a furnace body 12, a charging or batch end 14, a batch charging device 16 and a discharge or molten glass end 18. The overall flow of materials and glass through the furnace is indicated by arrow 20. The furnace has a first heat exchanger system which includes regenerator beds 26, 28, which are associated with ports 30, 32, 34, 36, 38, 44, 46, 48, 50, and 52 which contain air-fuel burners or air-fuel combustion devices to produce air-fuel flames 54, 56, 58, 60, and 62 as is well known in the art. In the mode of operation shown in FIG. 2, regenerator bed 26 receives air 66 and preheats it for air-fuel combustion flames 54, 56, 58, 60 and 62 respectively. At this time, regenerator bed 68 is being heated by flue gases 68 being exhausted from the furnace. After a period of time, as determined by the regenerator heat storage capacity, the flames, 54, 56, 58, 60 and 62 are extinguished and air-fuel flames are produced in ports 44, 46, 48, 50 and 52 utilizing air introduced through regenerator bed 28. As is well known in the art, the reversing flow alternately heats regenerator beds 26 and 28 to provide preheated air. In the prior art it has been known to introduce oxy-fuel boosting utilizing flames 74 and 76 produced by oxy-fuel burners located in the space between the charge end wall and the first air-fuel ports 30 and 52.

Although not illustrated in the figures the furnace may employ another type of regenerative heat exchanger using a rotating bed as a heat storage and transfer medium.

According to the present invention, the secondary heat exchanger system recovers heat from hot flue gas and transfers this heat to a material other than oxidant 2 which is heated in the primary heat exchanger system 52. The secondary heat exchanger system can comprise for example a batch and cullet preheater, a cullet preheater, a thermochemical recuperator, a thermochemical regenerator, a waste heat boiler, an oxygen preheater, or a natural gas preheater, or a combination of two or more heat exchangers of different types. As used herein, a thermochemical recuperator or thermochemical regenerator is heat exchanger in which heat from hot flue gas flowing through the recuperator or regenerator bed is transferred to a mixture of fuel (typically natural gas) and steam which thereby react by endothermic reforming reactions and the heat transferred from hot flue gas is converted to both thermal and chemical energy of the reactants, i.e., the mixture of fuel and steam. For example, the second heat exchanger system can consist of a sequential or a parallel combination of an oxygen preheater and a cullet preheater or solely consist of a waste heat boiler to produce steam.

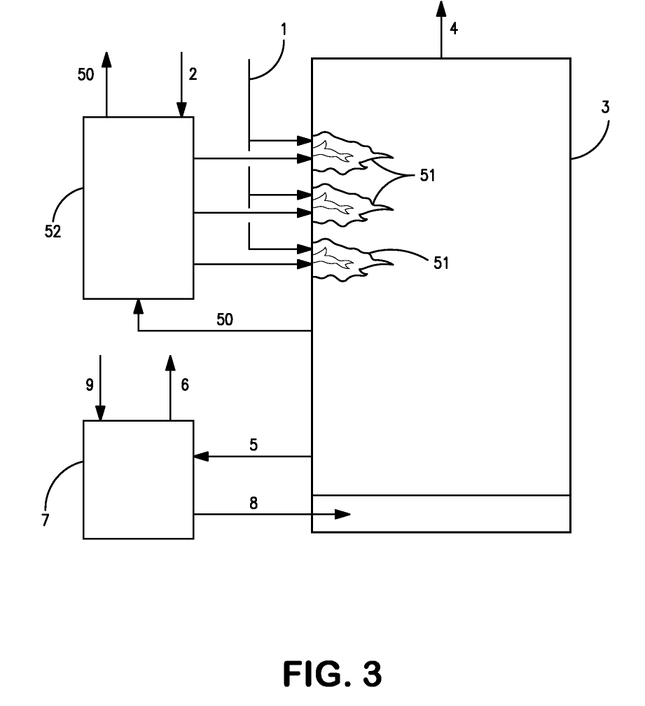

In a preferred embodiment of this invention the secondary heat exchanger system comprises a unit that heats batch/cullet incoming to the glassmelting furnace by radiative, convective and/or conductive heat transfer, preferably by a combination of radiative heat transfer with a convective heat transfer section to exchange heat between hot gaseous combustion products and the glassmaking material to a glassmelting furnace such as is shown in FIG. 1 or in FIG. 2. Such a unit is represented as unit 7 in FIG. 3, wherein stream 5 of combustion products pass into unit 7 and heat incoming glassmaking material 9 which is then fed to furnace 3 as stream 8 of heated glassmaking material to be melted in furnace 3. The combustion products, having transferred heat to the glassmaking materials in unit 7, exit unit 7 as stream 6.

Optionally a small portion of the hot combustion products can be exhausted from the furnace through a separate flue port (not shown) without heat recovery, for example, to stably control the furnace pressure.

Another aspect of the invention is the resulting apparatus that comprises first and second heat exchangers as described herein.

As noted above, one significant advantage of the present invention is that more of the energy content of the hot combustion products can be used to advantage, even though its temperature is higher as being obtained directly from the furnace without passing through a regenerator or a recuperator, without requiring any significant reduction in the temperature of the stream (prior to its entry into the second heat exchange system 7) such as by adding a diluent fluid stream or by passing through another heat exchanger.

The stream 6 of cooled combustion products emerging from heat transfer unit 7, or from a subsequent heat exchanger, can, if desired, be subjected to treatment steps that may be desirable or necessary before the stream is discharged to the atmosphere or employed as a feed stream to a chemical processing stage. For instance, the stream can be passed through an electrostatic precipitator or equivalent apparatus to remove fine particulate contaminants. The stream can be treated to remove gaseous atmospheric pollutants such as sulfur oxides, such as by contacting the stream with a suitable absorbent or reactant such as Ca(OH)₂ or sodium carbonate.

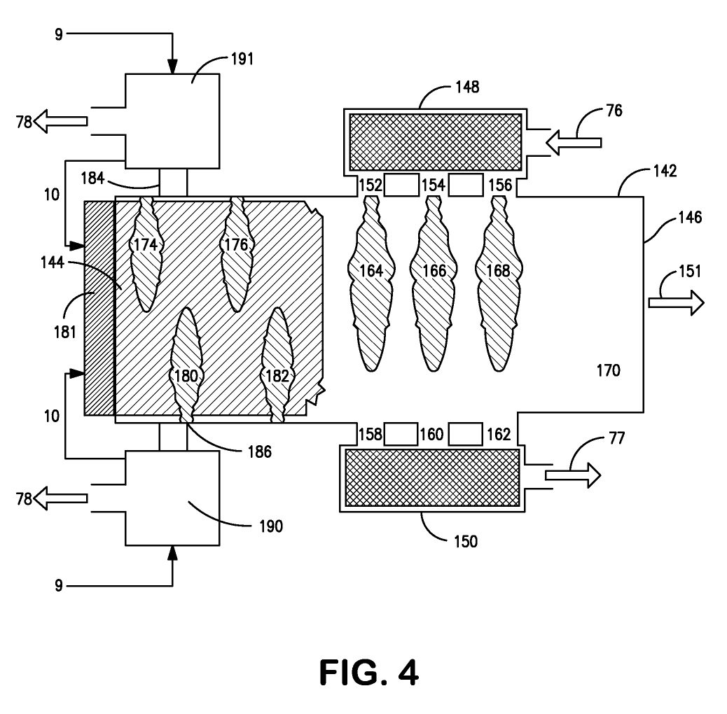

Turning to FIG. 4, which represents a glassmelting furnace coupled to regenerator beds 148 and 150 and coupled to a batch/cullet heat exchanger unit 7, preferred operation of this furnace takes into account overall heat balance and the characteristics of efficient heat transfer in regenerator beds 148 and 150. This operation then provides many useful results.

Referring to FIG. 4, a furnace 170 includes a furnace body 142, a charging or batch end 144, batch charger 181 and a discharge or molten glass end 146. The overall flow of materials and glass through the furnace is indicated by arrow 151. The furnace has a primary heat exchange system comprised of regenerator beds 148 and 150, which are associated with ports 152, 154, 156 and 158, 160, 162 respectively. In the mode of operation depicted in FIG. 4, regenerator bed 148 receives air 76 and preheats it for air-fuel combustion flames 164, 166, 168 respectively. Regenerator 150 is at this time being heated by a portion of hot combustion product gases 77 being exhausted from the furnace. The secondary heat exchanger system comprises in this example heat exchangers 190 and 191 which are batch/cullet preheaters in which incoming batch/cullet glassmaking material 9 is heated by the remaining portion of hot combustion products gases 78 being exhausted out of the furnace through exhaust gas ports 184 and 186 which connect the furnace with the heat exchange units 190 and 191. In this example flames 164, 166, and 168 produced by air-fuel combustion are positioned close to the discharge end of the furnace, and flames 174, 176, 180, and 182 produced by oxy-fuel combustion are positioned near the charging end of the furnace. Batch/cullet glassmaking material 10 having been heated in the secondary heat exchanger system of heat exchange units 190 and 191 is fed from units 190 and 191 to the furnace to be melted therein.

In known manner, the flow of air through one regenerator bed into the furnace and the flow of combustion products through the other regenerator bed out of the furnace are periodically switched so that each flow passes through the other bed. The switching of these flows can be accomplished in known manner, such as using a valve that is connected to a source of oxidant (such as air) and to a flue outlet stack, and is connected to each regenerator, and the valve can be alternated between one position in which oxidant flows to one bed and combustion products pass out from the other bed, and another position in which oxidant flows to the other bed and combustion products are received from the one bed.

The flow split ratio of the hot flue gas going into primary heat exchanger system (either regenerator bed 148 or 150) and into secondary heat exchange system unit(s) 7 or 190 and 191 can be varied to optimize the overall heat recovery efficiency. As mentioned previously, there is an inherent limitation in the maximum amount of waste heat recoverable in the regenerators and recuperators used for glass melting and other industrial furnaces. The heat capacity rate of the flue gas stream is typically about 35% more that the heat capacity rate of combustion air. Thus, even with a thermodynamically ideal regenerator or a recuperator where the air preheat temperature approaches the temperature of the entering hot flue gas, at least 26% [(1.35-1.0)/1.35=0.26] of the enthalpy content of the entering flue gas remains in the flue gas after passing through the regenerator. For a retrofit application to an existing regenerative furnace such as is shown in FIG. 2 or a new furnace application, about 10 to 40%, preferably about 15 to 30%, of the total flue gas is introduced into a unit 7 in FIG. 3 or units 190 and 191 in FIG. 4, bypassing the existing regenerators, recuperators, or other indirect heat exchangers present in order to reduce the heat capacity rate ratio of the hot flue gas to the combustion air to less than 1.3, preferably to less than 1.2, more preferably to less than 1.1 or even less than 1.0. Clogging of passages in regenerators, especially near the ports close to the batch charger is a common problem especially as time in use passes following the start of a new campaign of regenerator beds. Often in current practice not using the present invention, the furnace firing capacity has to be reduced because of the reduced combustion air capacity through these passages near the end of the furnace campaign. The present invention offers a synergistic solution to this problem and, at the same time, improves the furnace productivity and reduces the fuel consumption. By extracting a portion of the hot combustion products that would otherwise be fed through these passages, a section of the regenerator close to the charge is eliminated and/or the gas flow through the clogged passages is reduced. Also, since fuel consumption is reduced by preheating the glassmaking material (batch/cullet), the combustion air flow rate through the remaining passages is proportionally reduced.

As described elsewhere, operation of a regenerative heat exchanger involves periodically reversing the duties of the beds, such that the flow of hot combustion products is changed from a bed through which the combustion products have been flowing to another bed through which incoming oxidant has been flowing, and the flow of the incoming oxidant is changed from the bed through which the oxidant had been flowing to the bed through which the hot combustion products had been flowing. During this reversal, which typically takes 20 to 30 seconds, no fuel is fed to burners 51 (or ports such as ports 152, 154 and 156, as the case may be) but the flow of incoming oxidant is continued into the furnace through the regenerators. During this reversal periods, a portion of the preheated air (since no “hot combustion products” are available) is continuously introduced into the second heat exchanger system.

The present invention can be combined with partial conversion of the furnace to oxy-fuel combustion where one or two pairs of regenerator ports closest to the charge end of the furnace are closed and replaced with one to two pairs of oxy-fuel burners. One to two flue ports are placed in the same area to extract hot flue gas into the secondary heat exchanger system 7 in FIG. 3 or units 190 and 191 in FIG. 4, which preferably comprises one to two radiative heat exchange units. In the present invention, less furnace heating is required near the inlet for the glassmaking materials for the same glass production rate, since the glassmaking materials are already preheated before they are fed into the furnace.

When the secondary heat exchanger system 7 7 in FIG. 3 or units 190 and 191 in FIG. 4 is a preheater for incoming glassmaking ingredients, the preferred amount of hot combustion products extracted from the furnace is determined by the desired maximum preheat temperature of the glassmaking material in the preheater unit (s). For common soda lime glass furnaces, the maximum preheat temperature is about 1300 F due to the tendency of such materials to be adherent at higher temperatures. Preferably the preheat temperature is between 600 and 1300° F. More preferably the preheat temperature is between 700 and 1100° F. For improved heat recovery efficiency, the unit 7 7 in FIG. 3 or units 190 and 191 in FIG. 4 should be designed to cool the flue gas to below 700° F., preferably below 550° F.

### EXAMPLE

Table 1 shows an illustrative comparison of the energy balances of (Case 1) 450 short tpd regenerative container glass melting furnace with five ports to a regenerative-type indirect heat exchanger, (Case 2) the same furnace with a conventional batch cullet preheater to preheat batch/cullet to 572° F., (Case 3) a modified 450 short tpd regenerative container glass melting with the first pair of ports converted to continuous flue ports with the present invention to preheat batch/cullet to 932° F., and (Case 4) a modified 450 short tpd regenerative container glass melting with the first pair of ports converted to continuous flue ports and the second pair of ports closed and replaced with one to two pairs of oxy-fuel burners with the present invention to preheat batch/cullet to 932° F. Table 2 shows the corresponding conditions and assumptions used for the performance of the regenerators.

A 50-50 mixture of batch and cullet is assumed in all cases. Case 1 represents the baseline conditions of the existing furnace for comparison. In Case 2 the flue gas after the regenerators is introduced into a conventional batch/cullet preheater to preheat the mixture of batch and culet to 572° F. In Case 3 the first ports of the regenerators (i.e., the pair of ports closest to the batch charger) are taken out of service and replaced by a pair of flue ports. 24.5% of the total flue gas is continuously extracted from the air fired glass melting furnace through the flue ports and directly introduced into a radiative batch/cullet preheater unit 7 to preheat the glassmaking material. The remaining flue gas, i.e., 75.5% of the total flue gas, passes through the existing regenerators to preheat air. The heat recovery efficiency of the regenerators is improved as the heat capacity rate ratio of the hot flue gas to the combustion air is reduced and approaches 1.0. As a result the flue gas temperature leaving the regenerators is reduced, resulting in a reduced heat loss to the flue gas after the regenerators. In Case 4 the first and second ports of the regenerators are closed off and taken out of service and replaced by a pair of flue ports. One to two pairs of oxy-fuel burners are installed near the first and second ports to control the temperature in this zone. 31% of the total flue gas including the flue gas generated from the oxy-fuel burners is continuously extracted through the flue ports and directly introduced into a radiative batch/cullet preheater unit 7 to preheat the glassmaking material. The remaining flue gas, i.e., 69% of the total flue gas, passes through the existing regenerators to preheat air. The heat recovery efficiency of the regenerators is improved as the heat capacity rate ratio of the hot flue gas to the combustion air is reduced and approaches 1.0. As a result the flue gas temperature leaving the regenerators is reduced, resulting in a reduced heat loss to the flue gas after the regenerators. The oxidant used in the oxy-fuel burners is not preheated in the regenerators. Specific assumptions and calculated results are provided below for comparison.

In Case 1, the flue gas enters the regenerator at 2850° F. and leaves at 950° F. The air preheat temperature after the regenerator is 2300° F. In Case 2, the flue gas enters the regenerator at 2850° F. and leaves at 870° F. due to a heat exchanger efficiency gain from the reduce flow rates of flue gas and combustion air from fuel reduction, although the heat capacity rate ratio remains very close to Case 1. The air preheat temperature after the regenerator is assumed to be 2300° F. The flue gas then enters a downstream conventional BCP at about 870° F. and leaves the BCP at 433° F. by preheating the batch/cullet from 77° F. to 572° F. In Case 3 the flue gas enters the regenerator at 2850° F. and leaves at 448° F. due to an efficiency gain from (1) the reduction in the heat capacity rate ratio from 1.36 to 1.01 and also (2) the reduce flow rates of flue gas and combustion air. The air preheat temperature after the regenerator is assumed to be 2130° F. The flue gas entering the radiative heat exchanger with a convective heat recovery section (unit 7), leaves it at 360° F. by preheating the batch/cullet glassmaking material from 77° F. to 932° F. In Case 4, The flue gas enters the regenerator at 2850° F. and leaves at 480° F. due to an efficiency gain from (1) the reduction in the heat capacity rate ratio from 1.36 to 1.0 and also (2) the reduce flow rates of flue gas and combustion air. The air preheat temperature after the regenerator is assumed to be 2200° F. The flue gas entering the radiative heat exchanger with a convective heat recovery section (unit 7) leaves it at 418° F. by preheating the batch/cullet glassmaking material from 77° F. to 932° F. The oxidant used in the oxy-fuel burners is not preheated in the regenerators

TABLE 1
Furnace Energy Balance

| | | CASE 2 | CASE 3 | CASE 4 |
|---|---|---|---|---|
| | CASE 1 | PH T = | PH T = | PH T = |
| | Baseline | 572° F. | 932° F. | 932° F. |
| ENERGY INPUT | | | | |
| (MMBTU/TON) | | | | |
| FUEL | 4.05 | 3.47 | 3.27 | 3.09 |
| OXIDANT PREHEAT | 1.84 | 1.57 | 1.36 | 0.98 |
| BATCH/CULLET PREHEAT | 0.00 | 0.29 | 0.47 | 0.47 |
| TOTAL INPUT | 5.88 | 5.31 | 5.09 | 4.54 |
| ENERGY OUTPUT | | | | |
| (MMBTU/TON) | | | | |
| ENERGY TO GLASS | 1.49 | 1.49 | 1.49 | 1.49 |
| FLUE LOSSES (TOTAL) | 3.63 | 3.06 | 2.87 | 2.36 |
| WALL HEAT LOSSES | 0.76 | 0.76 | 0.73 | 0.69 |
| (TOTAL) | | | | |
| TOTAL OUTPUT | 5.88 | 5.31 | 5.09 | 4.54 |

TABLE 2
Regenerator Energy Balance and Heat Capacity Rates

| | | CASE 2 | CASE 3 | CASE 4 |
|---|---|---|---|---|
| | CASE 1 | PH | PH | PH |
| | Baseline | T = 572° F. | T = 932° F. | T = 932° F. |
| REGEN FLUE GAS FLOW RATE (SCFH) | 933,261 | 795,619 | 562,608 | 406,004 |
| COMBUSTION AIR FLOW RATE (SCFH) | 759,158 | 649,856 | 613,127 | 459,784 |
| COMBUSTION AIR PREHEAT TEMP (F.) | 2,300 | 2,300 | 2,130 | 2,200 |
| FLUE GAS TEMP BEFORE REGEN (F.) | 2,850 | 2,850 | 2,850 | 2,850 |
| FLUE GAS TEMP AFTER REGEN (F.) | 950 | 870 | 448 | 480 |
| AIR LEAKAGE INTO REGEN (SCFH) | 56,117 | 56,117 | 44,894 | 33,670 |
| INPUT | | | | |
| FLUE GAS SENSIBLE HEAT (MMBTU/HR) | 60.0 | 51.1 | 36.2 | 26.7 |
| FURNACE RADIATION TO REGEN | 4.14 | 4.14 | 3.31 | 2.48 |
| TOTAL IN (MMBTU/HR) | 64.13 | 55.21 | 39.49 | 29.14 |
| OUTPUT | | | | |
| AIR PREHEAT (MMBTU/HR) | 34.42 | 29.46 | 25.45 | 18.38 |
| FLUE GAS SENSIBLE HEAT (MMBTU/HR) | 16.8 | 12.9 | 4.1 | 3.3 |
| LEAKED AIR SENSIBLE HEAT (MMBTU/HR) | 0.9 | 0.8 | 0.3 | 0.3 |
| HEAT LOSSES (MMBTU/HR) | 12. | 12 | 9.6 | 7.2 |
| TOTAL OUT (MMBTU/HR) | 64.13 | 55.21 | 39.49 | 29.14 |
| CALCULATION OF HEAT CAPCITY RATES | | | | |
| TEMPERATURE (F.) | 2,850 | 2,850 | 2,850 | 2,850 |
| SENSIBLE HEAT OF COMBUSTION AIR | 44.2 | 37.8 | 35.7 | 26.8 |
| HEAT CAPACITY RATE | | | | |
| HEAT CAPACITY RATE - AIR (BTU/F./HR) | 15,928 | 13,634 | 12,864 | 9,647 |
| HEAT CAPACITY RATE - FLUE GAS | 21,634 | 18,419 | 13,048 | 9,612 |
| (BTU/F./HR) | | | | |
| HEAT CAPACITY RATE RATIO - FLUE/AIR | 1.36 | 1.35 | 1.01 | 1.00 |

As shown in the tables above, the fuel requirement is reduced from 4.05 MMBtu/ton for the baseline Case 1, to 3.47 MMBtu/ton for Case 2 with a conventional batch/cullet preheater, to 3.27 MMBtu/ton for Case 3 with the present invention, and to 3.09 MMBtu/ton for Case 4 with supplemental oxy-fuel burners with the present invention.

The parallel heat recovery integration method of the present invention (Cases 3 and 4) is clearly more efficient compared to the conventional sequential heat recovery integration method (Case 2) where the total flue gas volume first passes through the regenerators and the remaining sensible heat in the cooled flue gas is recovered in a downstream batch-cullet preheater. This invention enables a higher preheat temperature for batch/cullet and also improves the heat recovery efficiency of regenerators at the same time, hence, improves the overall energy efficiency of air fired glass melting furnaces. The present invention is particularly useful in combination with a radiative heat exchange with a convective heat recovery section (unit 7) which can take the hot flue gas at about 2500-2700° F. and directly cool the hot flue gas, without dilution air or water to about 400 to 500° F.

Although a five port regenerative furnace is used in the above illustrative example, the present invention is also applicable to end port regenerative furnaces, recuperative furnaces and many other air fired furnaces. The location(s) of the flue port(s) to introduce the second stream of hot combustion products into the second heat recovery system can be in the front, side or back walls or even on the furnace roof. As mentioned earlier, the secondary heat exchanger system can contain more than one type of heat recovery unit. For example, the second hot flue gas stream can be introduced first to a recuperator preheating oxygen used for the supplemental oxy-fuel burners and then the partly cooled flue gas is introduced to a cullet preheater without heating batch materials. Another example is to introduce the second hot flue gas stream first to a radiative batch/cullet preheater without a convective section and then the cooled flue gas is introduced to a waste heat boiler to generate steam. Many other combinations of heat exchangers are within the scope of the present invention. Although the heat capacity rate ratios in the above examples Case 3 and Case 4 are reduced to close to 1.0, the optimum ratio is not necessarily 1.0 and can be significantly below 1.0 if the second heat exchanger system can handle more flue gas volume and recover the waste heat more efficiently than the regenerators. The most energy efficient condition for the total furnace system is achieved when the flue gas temperatures downstream of the first and second heat exchangers are both reduced to below 600 F, more preferably below a lowest practical value of about 300-400 F.

What is claimed is:

1. A glassmelting method comprising
(A) passing glassmaking material into a glassmelting furnace;
(B) combusting fuel with gaseous oxidant having an overall average oxygen content of at least 20.9 vol. % oxygen to produce heat for melting said glassmaking material in said glassmelting furnace and thereby producing hot combustion products;
(C) passing hot combustion products from said glassmelting furnace, and a portion or all of said gaseous oxidant prior to combustion thereof in step (B), through a regenerative or recuperative primary heat exchanger system and heating the gaseous oxidant which is passed through said primary heat exchanger system by heat exchange in said primary heat exchanger system from the hot combustion products passed through said primary heat exchanger system, wherein the hot combustion products and oxidant which are passed through said primary heat exchanger system are passed at a heat capacity rate ratio of combustion products to oxidant of less than 1.3; and
(D) passing at least a portion of hot combustion products from said glassmelting furnace that are not passed through said primary heat exchanger through a secondary heat exchanger system and recovering sensible heat from said hot combustion products in said secondary heat exchanger system.

2. A method according to claim 1 wherein the hot combustion products and oxidant which are passed through said primary heat exchanger system are passed at a heat capacity rate ratio of combustion products to oxidant of less than 1.2.

3. A method according to claim 1 wherein the hot combustion products and oxidant which are passed through said primary heat exchanger system are passed at a heat capacity rate ratio of combustion products to oxidant of less than 1.1.

4. A method according to claim 1 wherein the hot combustion products and oxidant which are passed through said primary heat exchanger system are passed at a heat capacity rate ratio of combustion products to oxidant of less than 1.0.

5. A method according to claim 1 wherein more than 10% of the hot combustion products formed in step (B) are passed through said secondary heat exchanger system.

6. A method according to claim 1 wherein more than 20% of the hot combustion products formed in step (B) are passed through said secondary heat exchanger system.

7. A method according to claim 1 wherein more than 30% of the hot combustion products formed in step (B) are passed through said secondary heat exchanger system.

8. A method according to claim 1 wherein the stream of hot combustion products that is passed through said primary heat exchanger system exits said primary heat exchanger system at a temperature below 600 F.

9. A method according to claim 1 wherein said secondary heat exchanger system comprises one or more of a preheater for glassmaking material which is then passed into said glassmelting furnace, a thermochemical recuperator, a thermochemical regenerator, a waste heat boiler, an oxygen preheater, or a natural gas preheater.

10. A method according to claim 1 wherein said secondary heat exchanger system comprises a preheater in which one or both of batch and cullet which is passed into said glassmelting furnace is preheated.

11. A method according to claim 1 wherein said secondary heat exchanger system comprises a thermochemical recuperator to reform fuel with steam.

12. A method according to claim 1 wherein hot combustion products are passed into said secondary heat exchanger system at a temperature greater than 1800° F.

13. A method according to claim 1 wherein said glassmelting furnace combusts fuel and oxidant in at least one oxy-fuel burner wherein the oxidant combusted in said oxy-fuel burner is not preheated in said primary heat exchanger system.

14. A method of modifying a glassmelting furnace, comprising
providing a glassmelting furnace wherein fuel and gaseous oxidant having an oxygen content of at least 20.9 vol. % can be combusted to produce heat for melting glassmaking material in said furnace and produce hot gaseous combustion products, and a primary heat exchanger system coupled to the glassmelting furnace through which said hot combustion products can pass and through which at least a portion of said gaseous oxidant to be combusted in said furnace can pass and be heated by indirect heat exchange from said hot combustion products;
coupling to said glassmelting furnace a secondary heat exchanger system so that said secondary heat exchanger system can receive hot gaseous combustion products from said glassmelting furnace; and
providing one or more controllable dampers that can alter the volumes of said combustion products that are fed to said primary heat exchanger system and to said secondary heat exchanger system.

15. A method according to claim 14 wherein said furnace is a cross fired furnace wherein said primary heat exchanger system is a regenerator having more than one pair of ports into said regenerator, and wherein said modifying includes closing at least one pair of said ports.

16. A method according to claim 14 wherein said secondary heat exchanger system comprises a preheater in which one or both of batch and cullet which is passed into said glassmelting furnace is preheated.

17. A method according to claim 14 wherein said secondary heat exchanger system comprises a thermochemical recuperator to reform fuel with steam.

18. A method according to claim 14 wherein said furnace is an end-port fired regenerative furnace.

19. A method according to claim 14 wherein said glassmelting furnace combusts fuel and oxidant in at least one oxy-fuel burner wherein the oxidant combusted in said oxy-fuel burner is not preheated in said primary heat exchanger system.

20. A method of operating a furnace comprising
(A) combusting fuel in a furnace with gaseous oxidant having an overall average oxygen content of at least 20.9 vol. % oxygen to produce heat, and thereby producing hot combustion products;
(B) passing hot combustion products from said furnace, and a portion or all of said gaseous oxidant prior to combustion thereof in step (B), through a regenerative or recuperative primary heat exchanger system and heating the gaseous oxidant which is passed through said primary heat exchanger system by heat exchange in said primary heat exchanger system from the hot combustion products passed through said primary heat exchanger system, wherein the hot combustion products and oxidant which are passed through said primary heat exchanger system are passed at a heat capacity rate ratio of combustion products to oxidant of less than 1.3; and
(C) passing hot combustion products from said furnace that are not passed through said primary heat exchanger system through a secondary heat exchanger system and recovering sensible heat from said hot combustion products in said secondary heat exchanger system.

21. A method according to claim 20 wherein the hot combustion products and oxidant which are passed through said primary heat exchanger system are passed at a heat capacity rate ratio of combustion products to oxidant of less than 1.2.

22. A method according to claim 20 wherein the hot combustion products and oxidant which are passed through said primary heat exchanger system are passed at a heat capacity rate ratio of combustion products to oxidant of less than 1.1.

23. A method according to claim 20 wherein the hot combustion products and oxidant which are passed through said primary heat exchanger system are passed at a heat capacity rate ratio of combustion products to oxidant of less than 1.0.

24. A method according to claim 20 wherein more than 10% of the hot combustion products formed in step (B) are passed through said secondary heat exchanger system.

25. A method according to claim 20 wherein more than 20% of the hot combustion products formed in step (B) are passed through said secondary heat exchanger system.

26. A method according to claim 20 wherein more than 30% of the hot combustion products formed in step (B) are passed through said secondary heat exchanger system.

27. A method according to claim 20 wherein the stream of hot combustion products that is passed through said primary heat exchanger system exits said primary heat exchanger system at a temperature below 600 F.

28. A method according to claim 20 wherein said secondary heat exchanger system comprises one or more of a preheater for material which is then passed into said furnace to be heated or melted, a thermochemical recuperator, a thermochemical regenerator, a waste heat boiler, an oxygen preheater, or a natural gas preheater.

29. A method according to claim 20 wherein said secondary heat exchanger system comprises a preheater in which material which is then passed into said furnace is preheated.

30. A method according to claim 20 wherein said secondary heat exchanger system comprises a thermochemical recuperator to reform fuel with steam.

31. A method according to claim 20 wherein hot combustion products are passed into said secondary heat exchanger system at a temperature greater than 1800° F.

32. A method according to claim 20 wherein said furnace combusts fuel and oxidant in at least one oxy-fuel burner wherein the oxidant combusted in said oxy-fuel burner is not preheated in said primary heat exchanger system.

33. A method of heating a solid steel object comprising
(A) passing a solid steel object into a furnace for heating solid steel;
(B) combusting fuel with gaseous oxidant having an overall average oxygen content of at least 20.9 vol. % oxygen to produce heat for heating said object in said furnace and thereby producing hot combustion products;
(C) passing hot combustion products from said furnace, and a portion or all of said gaseous oxidant prior to combustion thereof in step (B), through a regenerative or recuperative primary heat exchanger system and heating the gaseous oxidant which is passed through said primary heat exchanger system by heat exchange in said primary heat exchanger system from the hot combustion products passed through said primary heat exchanger system, wherein the hot combustion products and oxidant which are passed through said primary heat exchanger system are passed at a heat capacity rate ratio of combustion products to oxidant of less than 1.3; and
(D) passing at least a portion of hot combustion products from said furnace that are not passed through said primary heat exchanger through a secondary heat exchanger system and recovering sensible heat from said hot combustion products in said secondary heat exchanger system.

34. A method according to claim 33 wherein the hot combustion products and oxidant which are passed through said primary heat exchanger system are passed at a heat capacity rate ratio of combustion products to oxidant of less than 1.2.

35. A method according to claim 33 wherein the hot combustion products and oxidant which are passed through said primary heat exchanger system are passed at a heat capacity rate ratio of combustion products to oxidant of less than 1.1.

36. A method according to claim 33 wherein the hot combustion products and oxidant which are passed through said primary heat exchanger system are passed at a heat capacity rate ratio of combustion products to oxidant of less than 1.0.

37. A method according to claim 33 wherein more than 10% of the hot combustion products formed in step (B) are passed through said secondary heat exchanger system.

38. A method according to claim 33 wherein more than 20% of the hot combustion products formed in step (B) are passed through said secondary heat exchanger system.

39. A method according to claim 33 wherein more than 30% of the hot combustion products formed in step (B) are passed through said secondary heat exchanger system.

40. A method according to claim 33 wherein the stream of hot combustion products that is passed through said primary heat exchanger system exits said primary heat exchanger system at a temperature below 600 F.

41. A method according to claim 33 wherein said secondary heat exchanger system comprises one or more of a preheater for material which is then passed into said furnace, a thermochemical recuperator, a thermochemical regenerator, a waste heat boiler, an oxygen preheater, or a natural gas preheater.

42. A method according to claim 33 wherein said secondary heat exchanger system comprises a preheater in which material which is then passed into said furnace is preheated.

43. A method according to claim 33 wherein said secondary heat exchanger system comprises a thermochemical recuperator to reform fuel with steam.

44. A method according to claim 33 wherein hot combustion products are passed into said secondary heat exchanger system at a temperature greater than 1800° F.

45. A method according to claim 33 wherein said furnace combusts fuel and oxidant in at least one oxy-fuel burner wherein the oxidant combusted in said oxy-fuel burner is not preheated in said primary heat exchanger system.

46. A method of melting solid aluminum comprising
(A) passing solid aluminum into a furnace for melting aluminum;
(B) combusting fuel with gaseous oxidant having an overall average oxygen content of at least 20.9 vol. % oxygen to produce heat for melting said aluminum in said furnace and thereby producing hot combustion products;
(C) passing hot combustion products from said furnace, and a portion or all of said gaseous oxidant prior to combustion thereof in step (B), through a regenerative or recuperative primary heat exchanger system and heating the gaseous oxidant which is passed through said primary heat exchanger system by heat exchange in said primary heat exchanger system from the hot combustion products passed through said primary heat exchanger system, wherein the hot combustion products and oxidant which are passed through said primary heat exchanger system are passed at a heat capacity rate ratio of combustion products to oxidant of less than 1.3; and
(D) passing at least a portion of hot combustion products from said furnace that are not passed through said primary heat exchanger through a secondary heat exchanger system and recovering sensible heat from said hot combustion products in said secondary heat exchanger system.

47. A method according to claim 46 wherein the hot combustion products and oxidant which are passed through said primary heat exchanger system are passed at a heat capacity rate ratio of combustion products to oxidant of less than 1.2.

48. A method according to claim 46 wherein the hot combustion products and oxidant which are passed through said primary heat exchanger system are passed at a heat capacity rate ratio of combustion products to oxidant of less than 1.1.

49. A method according to claim 46 wherein the hot combustion products and oxidant which are passed through said primary heat exchanger system are passed at a heat capacity rate ratio of combustion products to oxidant of less than 1.0.

50. A method according to claim 46 wherein more than 10% of the hot combustion products formed in step (B) are passed through said secondary heat exchanger system.

51. A method according to claim 46 wherein more than 20% of the hot combustion products formed in step (B) are passed through said secondary heat exchanger system.

52. A method according to claim 46 wherein more than 30% of the hot combustion products formed in step (B) are passed through said secondary heat exchanger system.

53. A method according to claim 46 wherein the stream of hot combustion products that is passed through said primary heat exchanger system exits said primary heat exchanger system at a temperature below 600 F.

54. A method according to claim 46 wherein said secondary heat exchanger system comprises one or more of a preheater for material which is then passed into said furnace, a thermochemical recuperator, a thermochemical regenerator, a waste heat boiler, an oxygen preheater, or a natural gas preheater.

55. A method according to claim 46 wherein said secondary heat exchanger system comprises a preheater in which material which is then passed into said furnace is preheated.

56. A method according to claim 46 wherein said secondary heat exchanger system comprises a thermochemical recuperator to reform fuel with steam.

57. A method according to claim 46 wherein hot combustion products are passed into said secondary heat exchanger system at a temperature greater than 1800° F.

58. A method according to claim 46 wherein said furnace combusts fuel and oxidant in at least one oxy-fuel burner wherein the oxidant combusted in said oxy-fuel burner is not preheated in said primary heat exchanger system.

59. A method of modifying a furnace, comprising
(A) providing a furnace wherein fuel and gaseous oxidant having an oxygen content of at least 20.9 vol. % can be combusted to produce heat and hot gaseous combustion products, and a primary heat exchanger system coupled to the furnace through which said hot combustion products can pass and through which at least a portion of said gaseous oxidant to be combusted in said furnace can pass and be heated by indirect heat exchange from said hot combustion products;
(B) coupling to said furnace a secondary heat exchanger system so that said secondary heat exchanger system can receive hot gaseous combustion products from said furnace; and
(C) providing one or more controllable dampers that can alter the volumes of said combustion products that are fed to said primary heat exchanger system and to said secondary heat exchanger system.

60. A method according to claim 59 wherein said furnace is a cross fired furnace wherein said primary heat exchanger system is a regenerator having more than one pair of ports into said regenerator, and wherein said modifying includes closing at least one pair of said ports.

61. A method according to claim 59 wherein said secondary heat exchanger system comprises a preheater in which material which is then passed into said furnace is preheated.

62. A method according to claim 33 wherein said secondary heat exchanger system comprises a thermochemical recuperator to reform fuel with steam.

63. A method according to claim 33 wherein said furnace is an end-port fired regenerative furnace.

64. A method according to claim 33 wherein said furnace combusts fuel and oxidant in at least one oxy-fuel burner wherein the oxidant combusted in said oxy-fuel burner is not preheated in said primary heat exchanger system.
